(19) United States
(12) Patent Application Publication
(10) Pub. No.: US 2008/0106247 A1
(43) Pub. Date: May 8, 2008

(54) Trimmed current mirror

(76) Inventor: Virgil Ioan Gheorghiu, Campbell, CA (US)

Correspondence Address: O2MICRO INC;C/O MURABITO, HAO & BARNES LLP, TWO NORTH MARKET STREET, THIRD FLOOR, SAN JOSE, CA, 95113, US

(21) Appl. No.: 11/728,119

(22) Filed: Mar. 23, 2007

Related U.S. Application Data
(60) Provisional application No. 60/857,264, filed on Nov. 6, 2006.

(51) Int. Cl. G05F 3/26; G05F 3/16

(52) U.S. Cl. 323/316; 323/312; 323/315

(57) ABSTRACT

A circuit is used for providing an output current that is proportional to an applied input current with high accuracy. The circuit includes an input circuit, a trimmable coupling circuit and an output circuit. The input circuit receives the input current and generates a reference input current in response to the input current. The trimmable coupling circuit is coupled to the input circuit for receiving the reference input current from the input circuit and for generating a reference output current for the output circuit. The trimmable coupling circuit is operable to achieve a predetermined ratio of the reference input current to the reference output current by causing internal terminals of the trimmable coupling circuit to settle to a substantially equal value. The output circuit receives the reference output current and outputs the output current in response to the receipt of the reference output current.

### CROSS REFERENCE TO PROVISIONAL APPLICATION

This application claims priority to the co-pending provisional patent application Ser. No. 60/857,264 Attorney Docket Number 02-IP-0321P, entitled “Trimmed Current Mirror,” with filing date Nov. 6, 2006, and assigned to the assignee of the present invention, which is herein incorporated by reference in its entirety.

### TECHNICAL FIELD

The present invention relates to current mirror, and in particular, to a circuit or a method for advanced trimmed current mirror.

### BACKGROUND ART

Current mirror circuits for copying a stable reference current, in general, are well known in the art and are used in many applications, such as bias elements and signal processing components.

Referring to PRIOR ART FIG. 1, a P-Metal Oxide Semiconductor Field Effect Transistor (MOSFET) current mirror 100 is illustrated. The current mirror 100 comprises a P-MOSFET 104, a resistor 106, a trimming resistor 108 and an operational amplifier 102. The operational amplifier 102 has a N-MOSFET input and P-MOSFETs which are not shown in PRIOR ART FIG. 1. Similarly, N-MOSFETs and a P-MOSFET input operational amplifier can also be used to form a similar current mirror in prior art.

The operational amplifier 102 produces a feedback signal returning back to the inverting input of the amplifier 102 through the MOSFET 104. The voltages of both the inverting input and the non-inverting input of the operational amplifier 102 are set substantially equal by the operational amplifier 102. The output of the operational amplifier 102 is coupled to the gate of the P-MOSFET 104 which can change its source to drain voltage in order to keep the voltages of the inverting input and the non-inverting input of the operational amplifier 102 substantially equal. As such, the ratio of the output current Iout to the input current Iin of the circuit 100 shown in PRIOR ART FIG. 1 is the same as that of the resistor 106 to the trimming resistor 108. Typically, the non-inverting input of the operational amplifier 102 is one Vgs lower than Vdda. The output current Iout can be adjusted to desired or predetermined value by trimming the value of the resistor 108. However, because of the resistor 108, the output voltage swing is limited to (Vdda−(Iout×R2)−(Vds)), where Vds is voltage across drain and source of the MOSFET 104.

Referring to PRIOR ART FIG. 2, a current mirror 200 using P-MOSFETs in the prior art is illustrated. Current mirror 200 includes a MOSFET 202 and a MOSFET 204 which are coupled to each other in parallel and may be driven by a stable reference current form the current mirror 200. In such a manner, the input current Iin is substantially replicated, or mirrored at the output of the MOSFET 202. Generally, one important factor in designing such a current mirror 200 is matching the input and output current according to the desired proportion or ratio.

For channel sizes of MOSFETs 204 and 202, when the channel length and width of MOSFET 202 are equal to those of MOSFET 204, the function of current transfer substantially depends on a multiplier factor which is denoted as m. In the current mirror 200 shown in the PRIOR ART FIG. 2, the value of output current Iout equals m times the value of input current Iin, i.e. (Iout=m×Iin). It is known to those skilled in the art that cascode circuit may also be used for the typical current mirror. In addition, N-MOSFETs may be used also for such current mirrors.

Assume the MOSFET 202 consists of m unit transistors in parallel, for example, m=3, and the MOSFET 204 is a unit transistor. For the current mirror structure 200 shown in PRIOR ART FIG. 2, a trimming procedure for achieving the desired ratio of Iout to Iin involves modifying the m value of the MOSFET 202. In order to modify the m value, parallel transistors of the MOSFET 202 for layout can be connected or disconnected, which is not easy to implement in process.

Referring to PRIOR ART FIG. 3, a basic bandgap circuit 300 is illustrated. An operational amplifier 322 drives the top terminals of resistors 312 and 314 and the resistors 312 and 314 are coupled to the inputs of the operational amplifier 322 such that both inputs of the operational amplifier 322 settle to substantially equal voltages, and then the voltages across resistors 312 and 314 are equal. By trimming the resistor 314, the currents through the resistors 312 and 314 can be made different. As such, the currents through emitters of Q1 and Q2 are different. In fact, the resistors 312 and 314 and the operational amplifier 322 with P-MOSFET input form a current generator which feeds two PNP bipolar transistors 302 and 304.

### SUMMARY OF THE INVENTION

It is an object of the present invention to provide a circuit or method for providing an output current that is proportional to an applied input current with high accuracy.

In order to achieve the above object, the one embodiment of the present invention provides a circuit comprising an input circuit, a trimmable coupling circuit and an output circuit. The input circuit receives the input current and generates a reference input current in response to the input current. The trimmable coupling circuit is coupled to the input circuit for receiving the reference input current from the input circuit and for generating a reference output current for the output circuit. The trimmable coupling circuit is operable to achieve a predetermined ratio of the reference input current to the reference output current by causing internal terminals of the trimmable coupling circuit to settle to a substantially equal value. The output circuit receives the reference output current and outputs the output current in response to the receipt of the reference output current.

### BRIEF DESCRIPTION OF THE DRAWINGS

Other objects, advantages, and novel features of the invention will become more apparent from the following detailed description when taken in conjunction with the accompanying drawing.

PRIOR ART FIG. 1 is a diagram showing a P-MOSFET current mirror using N-MOSFET input operational amplifier in prior art.

PRIOR ART FIG. 2 is a diagram showing a basic P-MOSFET current mirror in prior art.

PRIOR ART FIG. 3 is a diagram showing a basic bandgap structure in prior art.

FIG. 4 is a diagram showing a current mirror using a P-MOSFET cascode structure as input and using a N-MOSFET cascode structure as output, in accordance with one embodiment of the present invention.

FIG. 5 is a diagram showing a current mirror using a N-MOSFET cascode structure as input and using a P-MOSFET cascode structure as output, in accordance with one embodiment of the present invention.

FIG. 6 is a diagram showing a current mirror using a N-MOSFET cascode structure as input and using a N-MOSFET cascode structure as output, in accordance with one embodiment of the present invention

FIG. 7 is a diagram showing a current mirror using a P-MOSFET cascode structure as input and using a P-MOSFET cascode structure as output, in accordance with one embodiment of the present invention.

### DESCRIPTION OF EMBODIMENTS OF THE PRESENT INVENTION

Reference will now be made in detail to the embodiments of the present invention, trimmed current mirror. While the invention will be described in conjunction with the embodiments, it will be understood that they are not intended to limit the invention to these embodiments. On the contrary, the invention is intended to cover alternatives, modifications and equivalents, which may be included within the spirit and scope of the invention as defined by the appended claims.

Furthermore, in the following detailed description of the present invention, numerous specific details are set forth in order to provide a thorough understanding of the present invention. However, it will be recognized by one of ordinary skill in the art that the present invention may be practiced without these specific details. In other instances, well known methods, procedures, components, and circuits have not been described in detail as not to unnecessarily obscure aspects of the present invention.

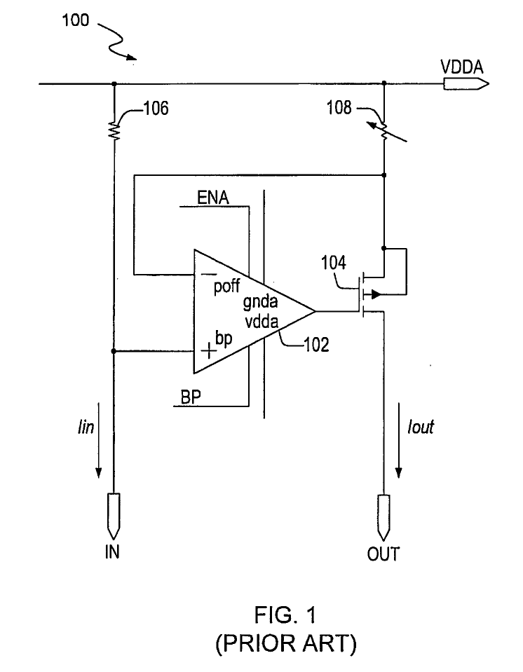

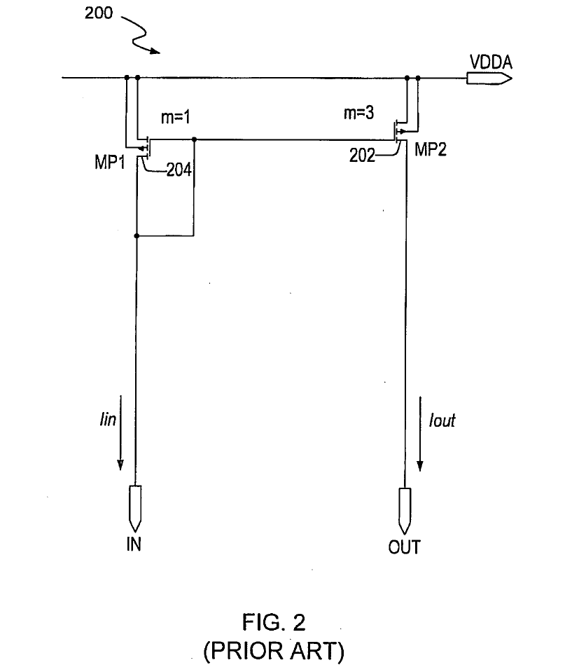

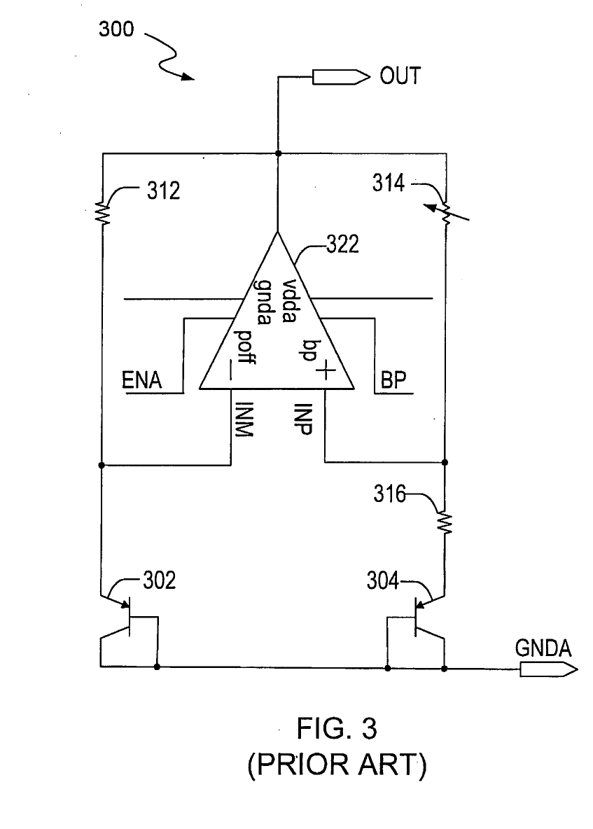

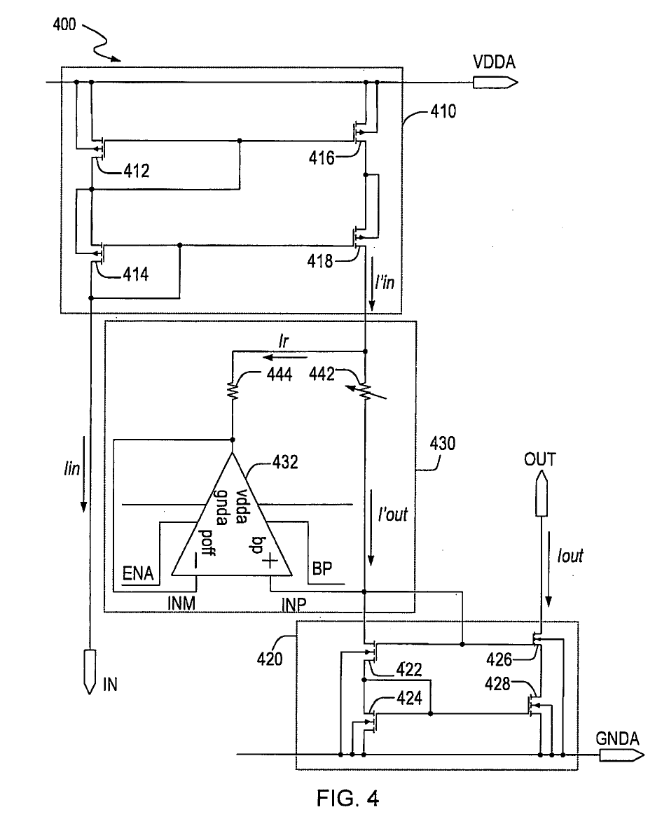

Referring to FIG. 4, a current mirror circuit 400 according to one embodiment of the present invention, that uses a P-MOSFET cascode structure as input and a N-MOSFET cascode structure as output is illustrated. The current mirror circuit 400 shown in FIG. 4 comprises an input circuit 410, an output circuit 420 and a trimmable coupling circuit 430.

In the input circuit 410, two transistors, such as P-MOSFETs 416 and 418 which are coupled to each other in series, are coupled in parallel to two transistors, such as P-MOSFETs 412 and 414 which are coupled to each other in series, so as to form a cascode current mirror. It will be appreciated by those skilled in the art that a cascode structure can be implemented with P-MOSFET or also with N-MOSFET. In the output circuit 420, two N-MOSFETs 428 and 426, which are coupled to each other in series, are coupled in parallel to two N-MOSFETs 424 and 422, which are coupled to each other in series, so as to form another cascode current mirror.

The trimmable coupling circuit 430 coupled to the input circuit 410 and the output circuit 420 comprises an operational amplifier 432, a resistor 444 and a trimming resistor 442.

As shown in FIG. 4, in accordance with one embodiment of the present invention, the non-inverting input port of the operational amplifier 432 is coupled to the drain of the MOSFET 422 and the trimming resistor 442. The inverting input port of the operational amplifier 432 is coupled to the output port of the operational amplifier 432 to form a negative feedback loop. It will be apparent for those skilled in the art that the input ports of an operational amplifier is a virtual short circuit, which means that the voltages applied to the two input ports are driven to substantially equal voltages. The output port of the operational amplifier 432 is coupled to the inverting input port and the resistor 444 for sourcing and sinking the current (I′in shown in FIG. 4) so as to keep the voltages across resistors 442 and 444 substantially equal.

The ratio of output current of the input circuit 410 flowing through the drain the MOSFET 418 to the input current of the circuit 410 is given by the ratio of device dimensions according to one embodiment of the present invention. The output current of the input circuit 410 serves as a reference input current for the trimmable coupling circuit 430, which is in response to the input current (Iin) of the current mirror circuit 400 and is input into the trimmable coupling circuit 430. Similarly, the transfer ratio of current through the MOSFETs 422 and 424 to that through the MOSFETs 426 and 428 is given by the ratio of the device dimensions. The current through MOSFETs 422 and 424 serves as a reference output current, which is output from the trimmable coupling circuit 430. The output current (Iout) is in response to the reference output current.

In one embodiment, the transfer ratio of current through the MOSFETs 412 and 414 to that through the MOSFETs 416 and 418 equals one, and the current (I′in) through the drain of the MOSFET 418, as the output current of the input circuit 410, will be equal to the input current (Iin) of the circuit 400. Likewise, when the transfer ratio of current through the MOSFETs 422 and 424 to that through the MOSFETs 426 and 428 equals one, the current (I′out) through the drain of the MOSFET 422, as the input current of the output circuit 420, will be equal to the output current (Iout) of the circuit 400.

In accordance with one embodiment of the present invention shown in FIG. 4, the output current Iout is calculated in Equation (1):

Iout=I′out=I′in−Ir=Iin−Ir (1)

### In Equation (1), Ir is the current flowing through the resistor 444. According to the Equation (1), Iout is less than Iin.

Because the voltage drops across the resistors 442 and 444 are equal as indicated above, the Equation (2) is obtained as follows:

Ir×R1=Iout×R2 (2)

In Equation (2), R1 and R2 are resistances of the resistors 444 and 442 respectively. The resistance R2 of the resistors 442 can be adjusted by trimming in process. There are many methods for trimming these resistors known by those skilled in the art. For example, the current mirror circuit 400 is fabricated in integrated circuit form.

From Equations (1) and (2), the Equation (3) is obtained as follows:

Iout=Iin×R1/(R2+R1) (3)

Where the ratio of resistance R2 to R1 is denoted as n, then the Equation (4) is obtained from Equation (3) as follows:

Iout=Iin/(n+1) (4)

The input current in is divided in accordance with the embodiment of the present invention. The accuracy of the output current can be achieved by trimming the resistor 442, which is easy to implement in process.

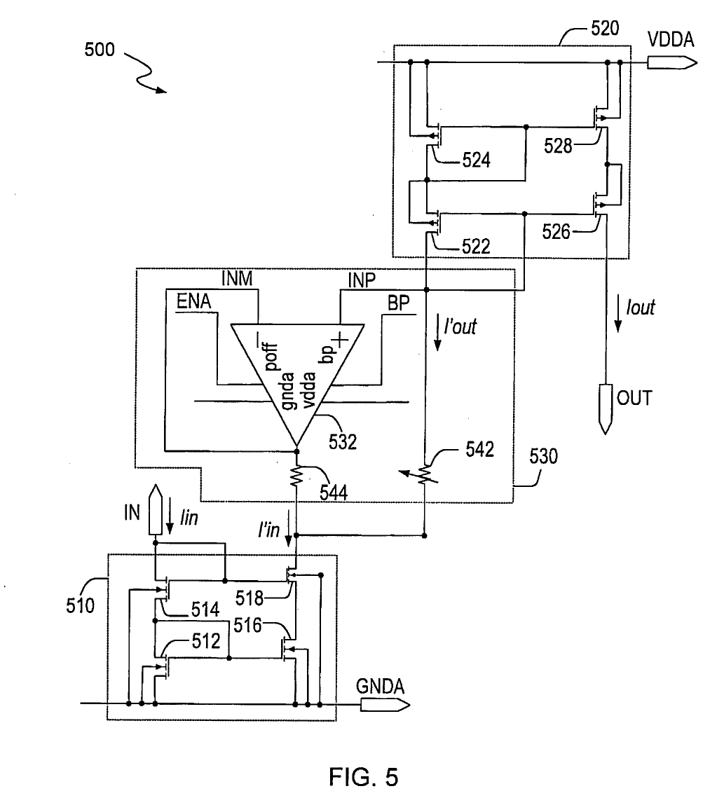

The circuit 500 in FIG. 5 depicts another embodiment according to embodiments of the present invention. The circuit 500 is similar to the circuit 400 shown in FIG. 4. As such, similar elements in FIGS. 4 and 5 are designated similar reference numbers. For clarity, similar elements in the circuits 400 and 500 have been previously described in association with the FIG. 4 and will not be described in detail herein.

As shown in FIG. 5, a current mirror circuit 500 using a N-MOSFET cascode structure as input and using a P-MOSFET cascode structure as output is illustrated, in accordance with one embodiment of the present invention. The current mirror 500 shown in FIG. 5 comprises an input circuit 510, an output circuit 520 and a trimmable coupling circuit 530.

In the input circuit 510, two N-MOSFETs 516 and 518 which are coupled to each other in series, are coupled in parallel to two N-MOSFETs 512 and 514 which are coupled to each other in series, so as to form a cascode current mirror. In the output circuit 520, two P-MOSFETs 528 and 526, which are coupled to each other in series, are coupled in parallel to two P-MOSFETs 524 and 522, which are coupled to each other in series, so as to form another cascode current mirror.

The trimmable coupling circuit 530 coupled to the input circuit 510 and the output circuit 520 comprises an operational amplifier 532, a resistor 544 and a trimming resistor 542.

The operational amplifier 532 may comprise an N-MOSFET input differential stage. The non-inverting input port of the operational amplifier 532 is coupled to the drain of the MOSFET 522 and the trimming resistor 542. The inverting input port of the operational amplifier 532 is coupled to the output port of the amplifier 532 to form a negative feedback loop so as to settle the voltages across the resistors 544 and 542 substantially equal.

Similar to the input current Iin of the current mirror circuit 400 shown in FIG. 4, is the input current Iin of the current mirror circuit 500 shown in FIG. 5. The output current Iout of the circuit 500 and the input current Iin of the circuit 500 are proportional to each other. The accuracy of the output current Iout can be achieved by trimming the resistor 542, which can be implemented in process as previously mentioned.

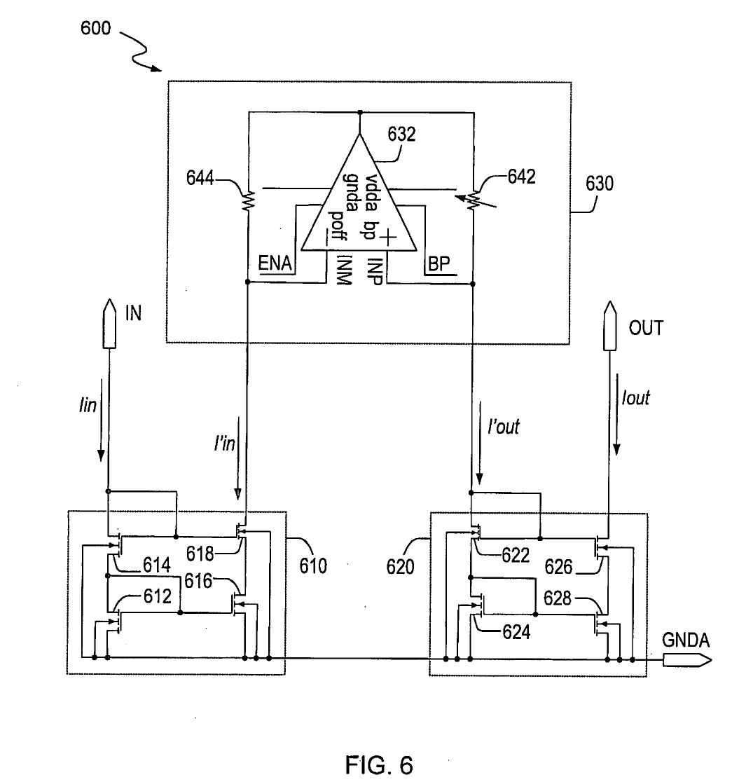

Referring to FIG. 6, a current mirror circuit 600 using a N-MOSFET cascode structure as input and using a N-MOSFET cascode structure as output in accordance with one embodiment of the present invention is illustrated. The current mirror 600 shown in FIG. 6 comprises an input circuit 610, an output circuit 620 and a trimmable coupling circuit 630.

In the input circuit 610, two N-MOSFETs 616 and 618 which are coupled to each other in series, are coupled in parallel to two N-MOSFETs 612 and 614, which are coupled to each other in series, so as to form a cascode current mirror. In the output circuit 620, two N-MOSFETs 622 and 624 which are coupled to each other in series, are coupled in parallel to two N-MOSFETs 626 and 628, which are coupled to each other in series, so as to form a cascode current mirror.

The trimmable coupling circuit 630 coupled to the input circuit 610 and the output circuit 620 comprises an operational amplifier 632, a resistor 644 and a trimming resistor 642.

The operational amplifier 632 comprises PMOS input differential stage. The non-inverting input port of the operational amplifier 632 is coupled to the drain of the MOSFET 622 and the trimming resistor 642. The inverting input port of the operational amplifier 632 is coupled to the drain of the MOSFET 618 and the resistor 644. As such, the voltages across the resistors 644 and 642 are settled substantially equal by the operational amplifier 632.

The ratio of output current flowing through the drain the MOSFET 618 of the input circuit 610 to the input current of the circuit 610 is given by the ratio of device dimensions. In one embodiment, when the transfer ratio of current through the MOSFETs 612 and 614 to that through the MOSFETs 616 and 618 equals one, the current I′in through the drain of the MOSFET 618, as the output current of the input circuit 610, will be equal to the input current in of the circuit 600. Likewise, when the transfer ratio of current through the MOSFETs 622 and 624 to that through the MOSFETs 626 and 628 equals one, the current I′out through the drain of the MOSFET 622, as the input current of the circuit 620, will be equal to the output current Iout of the circuit 600.

Since the operational amplifier 632 settles the voltages across resistors 644 and 642 are substantially equal as previously mentioned, the output current Iout is calculated in Equation (5):

I′out=Iout=I′in×(R1/R2)=Iin×(R1/R2) (5)

In Equation (5), R1 and R2 are resistances of the resistors 644 and 642, respectively. The resistance R2 of the resistors 642 can be adjusted by trimming in process. The ratio of resistances R2 to R1 is denoted as n. As such, from the Equation (5), the Equation (6) is obtained as follows:

Iout=Iin/n (6)

In one embodiment, if (R2/R1=n>1), then (Iout<Iin). The input current Iin of the circuit 600 is divided in this case. In another embodiment, if (n<1), (Iout>Iin). The input current Iin is multiplied. The accuracy of the output current Iout can be achieved by trimming the resistance R2.

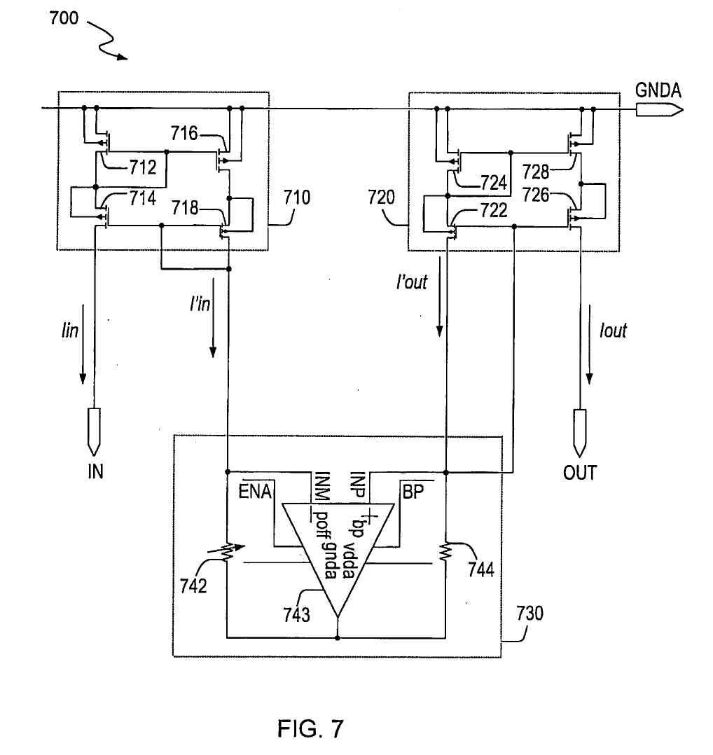

Referring to FIG. 7, a current mirror circuit 700 according to another embodiment of the present invention is illustrated. The circuit 700 shown in FIG. 7 is similar to the circuit 600 shown in FIG. 6, and the elements of the circuit 7 which are similar to the elements of the circuit 600 are designated similar reference numbers. For clarity, the similar elements in the circuit 700 which have been described in association with the circuit 600 shown in the FIG. 6 will not be described in detail hereinafter.

As shown in FIG. 7, the current mirror circuit 700 uses a P-MOSFET cascode structure as input and a P-MOSFET cascode structure as output. The current mirror 700 comprises an input circuit 710, an output circuit 720 and a trimmable coupling circuit 730.

In the input circuit 710, two P-MOSFETs 716 and 718 which are coupled to each other in series, are coupled in parallel to two P-MOSFETs 712 and 714 which are coupled to each other in series, so as to form a cascode current mirror. In the output circuit 720, two P-MOSFETs 728 and 726, which are coupled to each other in series, are coupled in parallel to two P-MOSFETs 724 and 722, which are coupled to each other in series, so as to form another cascode current mirror.

The trimmable coupling circuit 730 coupled to the input circuit 710 and the output circuit 720 comprises an operational amplifier 732, a resistor 744 and a trimming resistor 742.

The operational amplifier 732 may comprise a N-MOSFET input differential stage. The non-inverting input port of the operational amplifier 732 is coupled to the drain of the MOSFET 722 and a resistor 744. The inverting input port of the operational amplifier 732 is coupled to the drain of the MOSFET 718 and trimming resistor 742. As such, the voltages across the resistors 744 and 742 are settled substantially equal by the operational amplifier 743.

The output current Iout of the circuit 700 and the input current Iin of the circuit 700 are proportional to each other. In one embodiment, if the ratio value n of the resistance R2 of the resistor 742 to the resistance R1 of the resistor 744 is more than one, the output current Iout will be less than the input current Iin. The input current Iin is divided in this case. In another embodiment, if the ratio value n is less than one, the output current Iout will be larger than the input current Iin. The input current Iin is multiplied in this case. In order to achieve the output current accuracy, the trimming resistor 742 can be trimmed.

In accordance with other embodiments of the present invention, two transistors coupled in parallel can be used in place of the four transistors in the cascode structures shown in FIG. 4, FIG. 5, FIG. 6 and FIG. 7. Moreover, MOSFETs are used in the circuits 400, 500, 600 and 700 according to the embodiments of the present invention as shown in FIG. 4, FIG. 5, FIG. 6 and FIG. 7. However, in alternative embodiments, other transistors, such as Bipolar Junction Transistors (BJTs) Junction Field Effect Transistors (JFETs), or mixed transistors (bipolar and MOS), also can be used in please of the MOSFETs in the circuits 400, 500, 600 and 700. In addition, resistors used in the circuits 400, 500, 600 and 700 can be made of NWELL, PWELL, POLY, METAL etc. i.e. any type of resistors offered by process for integrated circuits.

In accordance with other embodiments of the present invention, operational amplifier used in FIG. 4, FIG. 5, FIG. 6 and FIG. 7 may comprise standard PMOS differential pair with an NMOS current mirror load, or an NMOS differential pair with an PMOS current mirror load, which is described only as an example for an operational amplifier and any of varied operational amplifier circuits can be employed. For example, an Operational Transconductance Amplifier (OTA) or a rail-to-rail input operational amplifier can be employed. Similarly, other variations can be employed for the operational amplifier, and the invention is not restricted in scope to any particular circuit or type of operational amplifier.

While the foregoing description and drawings represent the preferred embodiments of the present invention, it will be understood that various additions, modifications and substitutions may be made therein without departing from the spirit and scope of the principles of the present invention as defined in the accompanying claims. One skilled in the art will appreciate that the invention may be used with many modifications of form, structure, arrangement, proportions, materials, elements, and components and otherwise, used in the practice of the invention, which are particularly adapted to specific environments and operative requirements without departing from the principles of the present invention. The presently disclosed embodiments are therefore to be considered in all respects as illustrative and not restrictive, the scope of the invention being indicated by the appended claims and their legal equivalents, and not limited to the foregoing description.

What is claimed is:

1. A circuit for providing an output current that is proportional to an applied input current, said circuit comprising:
an input circuit for receiving said input current and for generating a reference input current in response to said input current;
a trimmable coupling circuit coupled to said input circuit for receiving said reference input current and for generating a reference output current wherein said trimmable coupling circuit is operable to achieve a predetermined ratio of said reference input current to said reference output current by causing internal terminals of said trimmable coupling circuit to settle to a substantially equal value; and
an output circuit coupled to said trimmable coupling circuit for receiving said reference output current and outputting said output current in response to the receipt of said reference output current.

2. The circuit as claimed in claim 1, wherein said input circuit further comprises a first current mirror for copying said input current to generate said reference input current.

3. The circuit as claimed in claim 2, wherein said first current mirror further comprises a first cascode current mirror.

4. The circuit as claimed in claim 3, wherein said first cascode current mirror comprises a first set of two transistors which are coupled to each other in series, are coupled in parallel to a second set of two transistors, which are coupled to each other in series.

5. The circuit as claimed in claim 1, wherein said trimmable coupling circuit comprises:
a first resistor coupled to said input circuit for receiving said reference input current;
a second resistor for generating a reference output current, wherein one of said first resistor and said second resistor is trimmable; and
an operational amplifier for settling voltages across said first and said second resistors to be substantially equal so as to achieve said predetermined ratio of said reference input current to said reference output current.

6. The circuit as claimed in claim 1, wherein said output circuit further comprises a second current mirror for copying said reference output current to generate said output current.

7. The circuit as claimed in claim 6, wherein said second current mirror further comprises a second cascode current mirror.

8. A circuit for providing an output current that is proportional to an applied input current, said circuit comprising:
an input circuit for receiving said input current and for generating a reference input current in response to said input current;
a trimmable coupling circuit coupled to said input circuit comprising:
a first resistor coupled to said input circuit for receiving said reference input current; and
a second resistor for generating a reference output current, wherein one of said first resistor and said second resistor is trimmable,
wherein said trimmable coupling circuit comprising an operational amplifier for settling voltages across said first and said second resistors to be substantially equal so as to achieve a predetermined ratio of said reference input current to said reference output current; and
an output circuit coupled to said trimmable coupling circuit for receiving said reference output current and outputting said output current in response to said reference output current.

9. The circuit as claimed in claim 8, wherein said input circuit further comprises a first current mirror for copying said input current to generate said reference input current.

10. The circuit as claimed in claim 9, wherein said first current mirror further comprises a first cascode current mirror.

11. The circuit as claimed in claim 10, wherein said first cascode current mirror comprises a first set of two transistors which are coupled to each other in series, are coupled in parallel to a second set of two transistors, which are coupled to each other in series.

12. The circuit as claimed in claim 10, wherein said first set of two transistors and said second set of two transistors are Metal Oxide Semiconductor Field Effect Transistors (MOSFETs).

13. The circuit as claimed in claim 10, wherein said first set of two transistors and said second set of two transistors are Bipolar Junction Transistors (BJTs).

14. The circuit as claimed in claim 10, wherein said first set of two transistors and said second set of two transistors are mixed transistors.

15. The circuit as claimed in claim 8, wherein said first and said second resistors are made of NWELL.

16. The circuit as claimed in claim 8, wherein said first and said second resistors are made of PWELL.

17. The circuit as claimed in claim 8, wherein said first and said second resistors are made of POLY.

18. The circuit as claimed in claim 8, wherein said first and said second resistors are made of METAL.

19. The circuit as claimed in claim 8, wherein said output circuit further comprises a second current mirror for copying said reference output current to generate said output current.

20. The circuit as claimed in claim 19, wherein said second current mirror further comprises a second cascode current mirror.

21. A trimmed current mirror circuit comprising:
an input current mirror circuit for receiving an input current;
a first resistor coupled to said input current mirror circuit;
a second resistor coupled in parallel to said first resistor, a resistance of one of said first resistor and second resistor being trimmable;
an operational amplifier coupled to said first and said second resistors for settling voltages across said first and said second resistors to be substantially equal, in order to achieve a predetermined ratio of currents flowing through said first and said second resistors; and
an output current mirror circuit coupled to said second resistor for outputting an output current.

22. The circuit as claimed in claim 21, wherein said operational amplifier comprises:
a standard transistor differential pair to be coupled to said first and said second resistors.

23. The circuit as claimed in claim 22, wherein said operational amplifier comprises a rail-to-rail operational amplifier.
